(19) United States
(12) Patent Application Publication
(10) Pub. No.: US 2024/0401374 A1
(43) Pub. Date: Dec. 5, 2024

(54) CLUTCH FOR A DOOR LOCK

(71) Applicant: ASSA ABLOY Access and Egress Hardware Group, Inc., New Haven, CT (US)

(72) Inventors: Douglas Clark, Wallingford, CT (US); Rick Leites, Milford, CT (US); Eric Palmieri, Rocky Hill, CT (US); Sharath Kumar Ramachandran, Rocky Hill, CT (US); Jeffrey Rodriguez, Newington, CT (US)

(73) Assignee: ASSA ABLOY Access and Egress Hardware Group, Inc., New Haven, CT (US)

(21) Appl. No.: 18/672,414

(22) Filed: May 23, 2024

Related U.S. Application Data
(60) Provisional application No. 63/470,084, filed on May 31, 2023.

(51) Int. Cl. E05B 47/00

(52) U.S. Cl. CPC E05B 47/0001; E05B 2047/0016; E05B 2047/0028

(57) ABSTRACT

A clutch may include a first rotating portion operatively couplable to a door handle. A clutch may include a second rotating portion operatively couplable to a lock spindle and configured to rotate to unlatch a door. A clutch may include a slider configured to configured to move between a first position and a second position to operatively engage and disengage, respectively, the first rotating portion and the second rotating portion. A clutch may include a magnet configured to apply a magnetic force to the slider to bias the slider toward the second position.

### CROSS-REFERENCE TO RELATED APPLICATIONS

This application claims the benefit under 35 U.S.C. § 119 (e) to U.S. Provisional Application No. 63/470,084, filed May 31, 2023 and entitled “CLUTCH FOR A DOOR LOCK,” which is herein incorporated by reference in its entirety.

### FIELD

The present disclosure relates generally to door locks and in particular to clutches for door locks.

### BACKGROUND

Door locks are used to provide or control access to a door. Door locks may be placed on both sides of a door and/or used in combination with exit devices. In some arrangements, a door trim may be operatively coupled to an exit device such that the door trim may be used to operate the exit device.

### SUMMARY

In some aspects, the techniques described herein relate to a clutch for a door lock, including a first rotating portion operatively couplable to a door handle, a second rotating portion operatively couplable to a lock spindle and configured to rotate to unlatch a door, a slider disposed at least partially between the first rotating portion and the second rotating portion and configured to move between a first position and a second position to operatively engage and disengage, respectively, the first rotating portion and the second rotating portion, and a magnet configured to apply a magnetic force to the slider to bias the slider toward the second position.

In some aspects, the techniques described herein relate to a clutch for a door lock, including a first rotating portion operatively couplable to an door handle, where the first rotating portion is further configured to rotate with the door handle, a second rotating portion operatively couplable to a lock spindle, where the first rotating portion is further configured to rotate with the lock spindle, a slider, the slider having a dog, the slider configured to connect the first rotating portion to the second rotating portion by engaging the dog with the first rotating portion and the second rotating portion when the slider is in a first position, and where the slider is configured disengage the dog from the first rotating portion and the second rotating portion to decouple the first rotating portion from the second rotating portion when the slider is in a second position, and a magnet configured to apply a magnetic force to the slider to hold the slider in the second position when the slider is in the second position.

In some aspects, the techniques described herein relate to a method for operating a lock clutch, the method including: moving a slider engaged with a first rotating portion from a first position to a second position, where in the first position the slider is engaged with a second rotating portion, and where in the second position the slider is not engaged with the second rotating portion, applying magnetic force with a magnet to the slider when the slider is in the second position to hold the slider in the second position, moving the slider from the second position to the first position to engage the slider with the second rotating portion such that the first rotating portion and the second rotating portion are configured to rotate together, rotating the first rotating portion about a lock axis while the slider is in the first position to rotate the second rotating portion, and moving the magnet away from the slider as the first rotating portion and the second rotating portion rotate about the lock axis, where the magnet is moved along a path orthogonal to a direction of the magnetic force.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a perspective view of an embodiment of a door lock installed on a door;

FIG. 2 shows an embodiment of a door lock with portions removed to show internal features;

FIG. 3A shows an exploded view of an embodiment of a lock clutch and the actuator for the lock clutch;

FIG. 3B shows an enlarged partial view of the lock clutch of FIG. 3A;

FIG. 4A illustrates an embodiment of a drive hub and a slider in a locked state;

FIG. 4B illustrates the drive hub and slider of FIG. 4A in an unlocked state;

FIG. 5 shows an exploded perspective view of an embodiment of a lock clutch;

FIG. 6 shows a perspective view of the lock clutch of FIG. 5 in an assembled configuration;

FIG. 7A shows a schematic of an embodiment of magnetic attraction and forces existing between an actuator and a slider;

FIG. 7B shows another schematic of an embodiment of magnetic attraction and forces existing between an actuator and a slider;

FIG. 8 shows a rear view of the lock of FIG. 2 with some components removed in a first state;

FIG. 9 shows a rear view of the lock of FIG. 8 in a second state; and

FIG. 10 illustrates a flow chart for an embodiment of a method for operating a lock clutch of a door lock according to some embodiments.

### DETAILED DESCRIPTION

Door locks may be used to control access to a door by enabling a user to open the door, such as by a door handle, when the lock is in an unlocked state and by inhibiting a user from opening the door when the lock is in a locked state. A door lock may use a clutch to decouple a user interface, such as a door handle, when the lock is in the locked state, thereby decoupling the door handle from the latch that secures the door. By decoupling the door handle from the latch, the clutch may lock the door (e.g. place the door lock in a state where operating the user interface/door handle does not operate the latch). Some door locks may be electrically operated, where an electric actuator may be used to switch the lock between a locked and an unlocked state.

The inventors have appreciated that it may be desirable for a clutch in a door lock to be robust so as to be minimally affected by friction, vibration, shock or intentional tampering with the door lock. The inventors have further appreciated that it may also be desirable for the clutch of a door lock to engage with relatively low applied forces, for instance to save power and extend battery life on electrically operated locks.

In view of the above, the inventors have recognized and appreciated improvements in clutches for door locks. In particular, the inventors have appreciated the benefits of a clutch for a door lock that includes a slider configured to slide between two positions to couple or decouple two rotating portions, where the clutch includes a magnet configured to generate an attractive magnetic force that biases the slider toward a position associated with a locked state of the clutch and associated door lock.

In some embodiments, a magnetic force may resist movement of the slider to a position associated with an unlocked state of the door lock. Such an arrangement may prevent external forces (e.g., bumping) from moving the slider from a locked position to an unlocked position to enable unauthorized use of the door lock. The clutch may include an actuator that may be operated to move the slider to the unlocked position to couple the two rotating portions, allowing for operation of the door lock. In some embodiments, a magnet may be disposed in a portion of the actuator and may be configured to attract a ferromagnetic portion of the slider toward the actuator. In some embodiments, a magnet may be disposed in a portion of the slider and may be configured to attract the slider toward a ferromagnetic portion of the actuator.

In addition to the above, the inventors have recognized the benefits of a clutch including a slider and a magnet configured to generate a magnetic force biasing the actuator toward a position associated with a locked state, where the slider is moved in a direction transverse to a direction of the magnetic force to allow the magnetic attraction to be disengaged when the slider is in a position associated with an unlocked state. As noted above, the inventors have appreciated the benefits of a clutch for a door lock that is configured to couple and decouple two rotating portions of a door lock with relatively low forces which may reduce battery life and may improve manual operation of the door lock (for example, by reducing the force employed by a user to operate the door lock). The inventors have appreciated that where a magnet is employed to generate an attractive magnetic force, movement of the slider is a direction transverse (e.g., orthogonal) to the attractive magnetic force may take less force than if the slider were moved in a direction directly opposing the magnetic force. In some embodiments, the slider may be configured to rotate with two rotating portions while the slider is in an unlocked position (corresponding to an unlocked state of the door lock). In some embodiments, rotation of the slider may move a portion of the slider away from the actuator so that the magnetic attractive force is broken between the magnet and the slider.

In some embodiments, a clutch for a door lock is configured to selectively couple a first rotating portion and a second rotating portion. In some embodiments, the first rotating portion may be associated with a door handle (e.g., door lever, knob, other user interface, etc.). The second rotating portion may be associated with a latch of the door lock (e.g., a lock spindle), such that rotating the second rotating portion may retract the latch. In some embodiments, the clutch may include an actuator such as an electromechanical actuator and a slider. The slider may be disposed between the first rotating portion and the second rotating portion, and may be configured to operatively couple the first rotating portion and the second rotating portion. The slider may be configured to move between a first position, where the first and second rotating portions are coupled, and a second position, where the first and second rotating portions are decoupled. The actuator may be operated (e.g., by a processor executing computer readable instructions) to selectively move the slider between the first position and the second position in association with locking or unlocking the door lock. In an unlocked state of the door lock the slider may be in the first position, so that the first and second rotating portions are operatively coupled and are able to rotate together. In a locked state of the door lock, the slider may be in the second position, so that the first and second rotating portion are not coupled and rotation of one rotating portion is not transferred to the other. According to exemplary embodiments herein, the slider may be biased to the second position (corresponding to the locked state) by a magnet. The magnet may generate a magnetic force that attracts the slider to the second position. In some embodiments, the magnet may be disposed on at least one of the actuator and the slider. In some embodiments, the magnet may hold the slider in contact with the actuator in the second position. In some embodiments, the magnet is disposed on the actuator and attracts a ferromagnetic portion of the slider. In some embodiments, the magnet is disposed on the slider and attracts a ferromagnetic portion of the actuator. In some embodiments, a first magnet is disposed on the slider and a second magnet is disposed on the slider which attract each other.

In some embodiments, a method of operating a clutch for a door lock includes moving a slider from a first position to a second position, where in the second position the slider decouples a first rotating portion from a second rotating portion. In the first position, the slider couples the first rotating portion and the second rotation portion so that torque may be transmitted between the first rotating portion and the second rotating portion. The method may further include holding the slider in the second position with a magnetic force generated by a magnet disposed on at least one of the slider and an actuator. In some embodiments, the slider may be initially moved from the first position to the second position by a biasing spring. The method may further include moving the slider from the second position to the first position with the actuator. In some embodiments, moving the slider from the second position to the first position may include moving the slider against a biasing force provided by the biasing spring. In some embodiments, a portion of the actuator and the slider may move together as the slider moves from the second position to the first position, such that the magnetic force does not oppose the movement from the second position to the first position.

According to some embodiments, a door lock may include a lever hub rotatably attached to the door handle and a drive hub rotatably attached to a spindle that may operate the latch. In an unlocked state, a clutch may include a slider having a dog, and the clutch may be clutched or declutched by the dog. The dog may be in rotational connection with one of the lever hub and the drive hub. At least the other of the lever hub and the drive hub may have a notch into which a portion of the dog may engage, such as in a locked state. The clutch including the dog may be free to translate radially with respect to lever hub and the drive hub. The slider may be slidably connected to one of the lever hub or the drive hub. In the locked state, the dog may be disengaged from the notch of the drive hub such that the lever hub and the drive hub are rotationally decoupled. In the unlocked state, the dog may engage with the notch of the drive hub, thereby rotationally coupling the lever hub and the drive hub so that they connectedly rotate (e.g., torque may be transmitted from the lever hub, through the dog, and to the drive hub). The dog may be biased in the locked state (e.g., disengaged from the notch) by attraction of a magnet with the dog or another portion of the slider that the dog may be attached to. In some embodiments, the magnet may be attached an actuator that may be employed to move the slider including the dog between a first position and second position to switch the clutch between an unlocked state and a locked state, respectively.

During operation of the lock, the lever hub and the drive hub may rotate, such as with the door handle. In some embodiments, rotation of lever hub and/or the drive hub may cause the magnet to move (e.g., translate) with respect to the dog, slider, or other portion of clutch to which it may be attracted. In some embodiments, the direction of movement of the magnet may be orthogonal to the direction of magnetic attraction between the magnet and dog, slider, or other portion of clutch. Moving the magnet in a direction orthogonal or at least traverse to a direction of magnetic attraction may permit the separation of the magnet from the dog, slider, or other portion of clutch at a force magnitude substantially less than a force that would be necessary to separate the magnet from the dog, slider, or other portion of clutch if the magnet were to be separated by applying a force to oppose the magnetic attraction (e.g., the force being applied parallel to the direction opposite of magnetic attraction). The dog, slider, or other portion of clutch may additionally be biased by a spring. The spring may provide a force coincident with the force of magnetic attraction. In some embodiments, the magnet may supplement the spring, such as to enhance robustness without significantly increasing actuation force over that of embodiments including only the equivalent spring.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

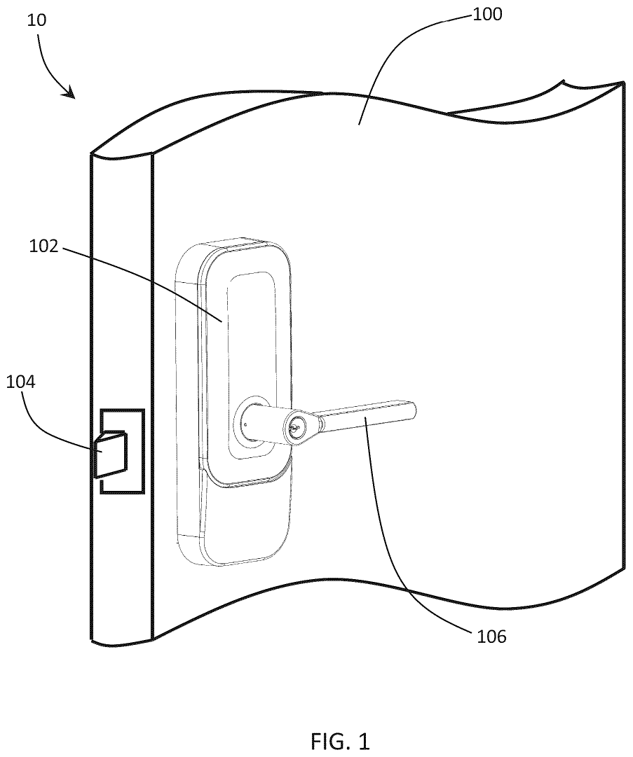

FIG. 1 shows a perspective view of a door lock as installed on a door. Door 10 includes door panel 100, door lock 102 and latch 104. A door handle 106 may be turned by a user to unlatch the latch 104 such as to open the door. Although a lever type door handle is illustrated, other types of user interfaces may be used, such as a door knob, thumb latch, pull, or other interface. In a locked state of the door lock 102, the user may not be able to operate the latch 104 by turning or attempting to turn the door handle 106. In some embodiments, the door handle 106 may freewheel in the locked state. A freewheeling door handle may be rotated by a user without actuating the latch 104 when the door is in a locked state. In other embodiments, the door handle may be rigid in the locked state such that the user may not be able to rotate the door handle to unlatch the latch. This embodiment may provide a user with tactile feedback that the door is in the locked state. In some embodiments, a door handle may be rigid in the locked state, but may also be operatively decoupled from the latch 104, so that even if force is applied to rotate the door handle 106 the latch 104 may not unlatch (e.g., retract). In an unlocked state of the door lock 102, the user may rotate the door handle 106 to unlatch the latch and open the door. While the foregoing was described with reference to door handles such as lever type door handles, door knobs and/or other user interfaces may be employed in some embodiments. In some embodiments, another door lock may be present on an opposite facing side of the door. Alternatively, in some embodiments an exit device or other door hardware may be attached to the other side of the door. Clutches according to embodiments herein may be employed in any door lock or combination of door hardware and door trims, as the present disclosure is not so limited. In some embodiments, clutches according to exemplary embodiments herein may be employed to selectively couple two rotating portions of a door lock, where a first rotating portion is associated with a user interface such as a handle, and a second rotating portion is associated with a door latch or bolt.

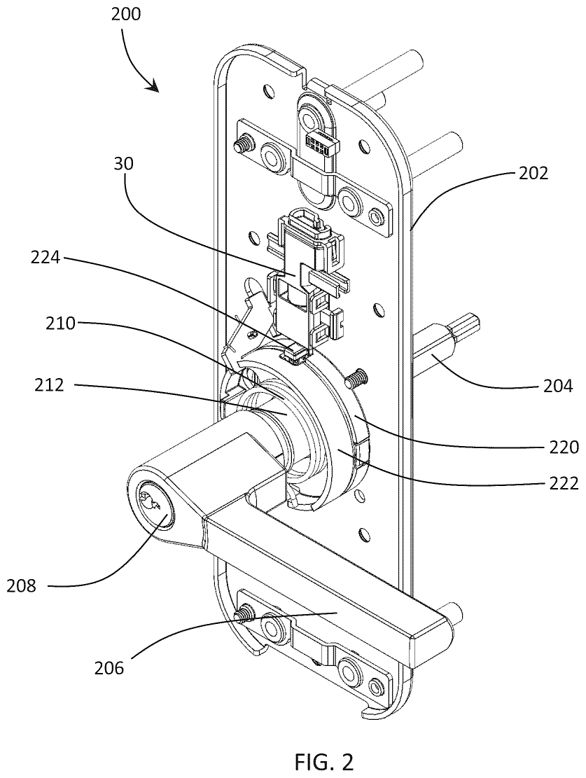

FIG. 2 shows an embodiment of a door lock 200 with portions removed to show internal features. As shown in FIG. 2, the door lock includes a mounting plate 202 may be used to attach the lock to a door panel or other lock hardware (e.g., an exit device). In some embodiments, the lock may be attached to the door panel by mounting a first lock on a first side of the door with a second lock (or other exit device) located on a second side of the door. The mounting plate may serve as a portion of a chassis of the lock, and some components of the lock may be attached to the mounting plate. The door lock 200 includes a door handle 206 for a user to operate the lock. In some embodiments as shown in FIG. 2, the door handle 206 includes a key cylinder 208. The user may switch the door lock 200 between a locked state and an unlocked state with the key cylinder. The door handle may be operatively connected to a lever hub 222, such that the lever hub may be rigidly connected with the door handle 206 such that the lever hub and door handle rotate together whenever the door handle is rotated. The lever hub may be connected to the door handle by a lever spindle 212 (e.g., outer spindle) which may be a portion of the door handle or may be a separate piece which may not be visible with a door handle installed. A handle return spring 210 may provide a return biasing force such as to return the door handle to free or neutral position when a user releases the handle. A free or neutral position may be a position in which a door handle 206 is horizontal as shown in FIG. 2, in some embodiments. In other embodiments where a lever type door handle is not employed, a free or neutral position may correspond to an unstressed (or least stressed) state of a handle return spring.

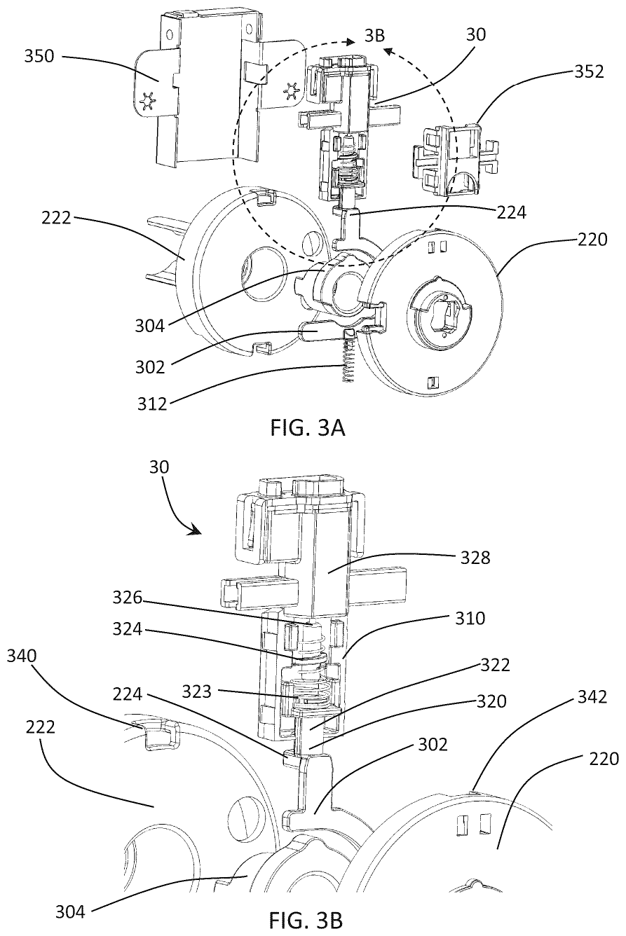

As shown in FIG. 2, the door lock 200 includes drive hub 220 located adjacent to the lever hub 222 and separated from the lever hub by a space. The drive hub 220 may be operatively connected to a lock spindle 204. The lock spindle 204 may operate a latch securing the door, for example, when the lock spindle is rotated. In a locked state, the drive hub 220 and the lever hub 222 may not be operatively connected such that rotation of one is not transferred to the other, or said another way, the lever hub 222 may rotate without rotating the drive hub 220. As the lock spindle is operatively connected to the drive hub 220, turning the lever hub 222 while the door lock in in the locked state may not turn the lock spindle 204 and therefore the associated latch may remain engaged. In some embodiments, the door lock 200 includes a dog 224 forming a portion of a slider (for example, see FIG. 3A). The dog 224 may translate between a first position and a second position. In the first position (illustrated in FIG. 2) the dog 224 may be disengaged from at least one of the lever hub 222 and the drive hub 220 such that the lever hub and the drive hub are not operatively connected and may rotate independently. In the second position the dog 224 may engage with the lever hub 222 and the drive hub 220 such as to operatively connect the lever hub and the drive hub. As described in the foregoing, the first position may correspond to the locked state and the second position may correspond to the unlocked state. The dog 224 and the slider of which it is a portion, may be moved between the first state and the second state by an actuator 30. In some embodiments, the slider (and dog 224) may be biased to the first position by a spring (not visible) and/or by at least one magnet that may be disposed on a portion of the slider (e.g., dog 224) and/or the actuator 30. Examples of a magnet will be described in greater detail in reference the figures to follow.

In some embodiments, the lever hub 222 and the drive hub 220 may be disks. Each of the lever hub and the drive hub (e.g., lever disk and drive disk) may form at least part of a rotating portion of the lock. In some embodiments the lever hub may be part of a first rotating portion and the drive hub may be part of a second rotating portion (and vice versa). In some embodiments, the first rotating portion may be operatively couplable to a door handle (e.g., a door lever). In some embodiments, the second rotating portion may be operatively couplable to a lock spindle. The first and second rotating portions may include other rotating components, such as spindles, the door handle, cams and other components. In some embodiments, a slider may be included in a rotating portion of the lock.

FIG. 3A shows an exploded view of a lock clutch for a door lock and an actuator 30 for the lock clutch. Actuator 30 is enclosed by cover 350. An actuator drive cover 352 is illustrated removed from the actuator to show the internals of the actuator. A slider 302 includes a dog 224. The slider may be biased (such as into a position corresponding with the locked state) by spring 312. The slider 302 is disposed between a lever hub 222 and a drive hub 220. The slider may be slidably connected to one of the lever hub 222 and the drive hub 220. For example, in the embodiment of FIG. 3A, the slider is configured to be slidingly connected to the drive hub 220. The clutch includes a cam 304 configured engage and move the slider 302 based on rotation of a lock spindle, such as may occur with a rotation of a second door handle on an opposite face of the door. Different cams may be used in different embodiments and may be omitted in some embodiments.

FIG. 3B shows a close-up exploded view of the lock clutch and actuator 30 of section 3B in FIG. 3A. In some embodiments, the actuator 30 is a screw driven actuator and includes a frame 310 supporting a motor 328 with shaft 326 and a ram 322. The ram 322 is driven by a helical spring 323 engaged by a worm 324. The worm 324 engages with the helical spring 323 such that the worm acts as a lead screw, the flute of the worm engaging the helix of the spring in the manner of a nut. The helical spring is translated along an axis of the worm, the axis being parallel and colinear with the shaft 326. The shaft 326 is rotated by the motor 328 and in turn rotates the worm. The ram 322 is attached to an end portion of the helical spring 323 and moves along the frame 310 of the actuator under the force applied by the helical spring. The helical spring may provide compliance at endpoints of the actuator travel.

According to exemplary embodiments herein, an actuator may be an electric actuator. An actuator may include a DC motor, servo, stepper motor, brushless motor, or another suitable motor, in some embodiments.

In some embodiments as shown in FIG. 3B, the actuator 30 further includes a magnet 320 disposed within the ram. According to some embodiments, the magnet may be applied to or inserted in the ram while in other embodiments the entire ram may be magnetized. The magnet may be configured to apply a magnetic force to the dog 224 and/or to the slider 302 of which the dog may form a portion. The magnet 320 may provide a force that may bias or hold the dog 224 in a position corresponding to the lever hub 222 and the drive hub 220 being decoupled (for example, corresponding to a locked state of a door lock). In some embodiments, the magnetic force may bias the slider 302 to abut the ram 322 of the actuator. The force supplied by the magnet may supplement spring force applied by spring 312.

In some embodiments, the slider 302 may be constructed at least partially of a ferromagnetic material so as to allow for magnetic attraction by the magnet 320 between the ram 322 and the slider 302. In some embodiments, the slider 302 may be formed from steel, magnetic stainless steel, iron, nickel, cobalt or other suitable material. In some embodiments the slider may be a ferritic or martensitic grade of stainless steel such as 410 stainless. In some embodiments only a portion of the slider may be ferromagnetic, such as the dog 224, a portion of the dog or some other portion. The magnet(s) may be ferrite, neodymium, alnico, samarium cobalt, or other suitable material. In some embodiments, the slider, dog, or a portion thereof may be magnetized to serve as the magnet creating a magnetic attraction with a ferromagnetic ram. In other instances, both the ram and the slider may be magnetized or include magnets that may be attracted to each other. Any suitable arrangement of magnets and ferromagnetic material may be used to create the magnetic force.

In the unlocked state, a portion of the slider 302 such as the dog 224 portion of the slider engages with a notch 340 in the lever hub 222 and with notch 342 in drive hub 220. In some embodiments, the slider may remain engaged with at least a portion of one of the lever hub 222 and the drive hub 220 in all positions. For example, in a position associated with a locked state, the slider may remain engaged with the drive hub 220.

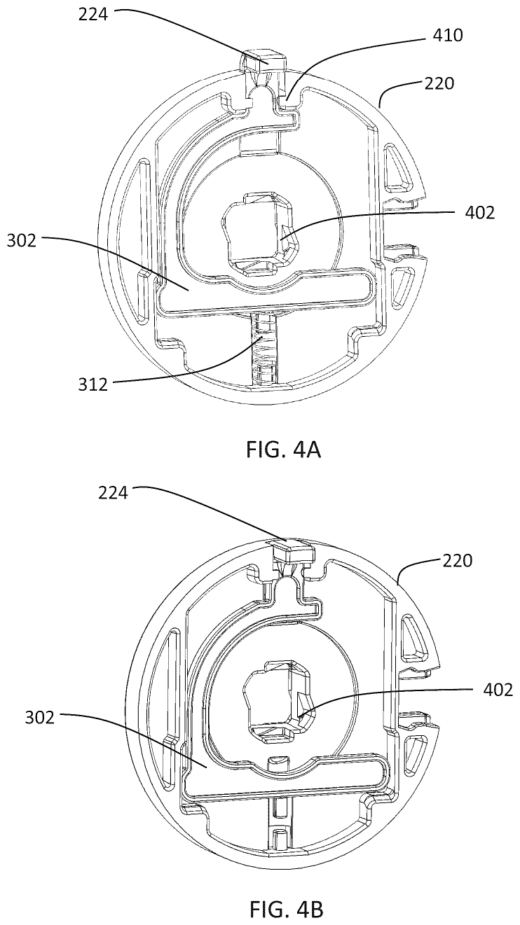

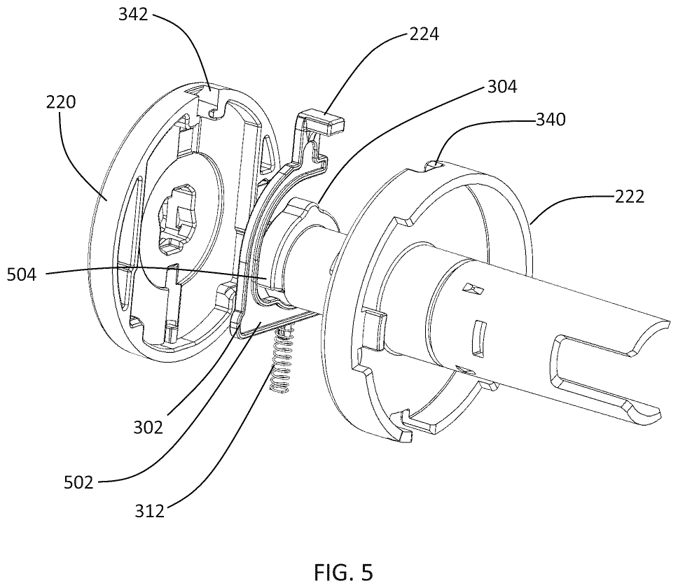

FIG. 4A illustrates an embodiment of a drive hub 220 and slider 302 in a locked state. As shown in FIG. 4A, the drive hub 220 slidably supports the slider 302. A guide 410 supports the slider within the drive hub 220. A spring 312 biases the slider such that the dog 224 portion of the slider 302 is outside a diameter of the disk forming the drive hub 220. A magnet (for example see FIG. 3B) may provide additional biasing force. In a locked state, the dog 224 may be in a position above a notch in a lever hub (for example, see FIG. 5) such that the dog will not engage the notch in the lever hub causing the lever hub and the drive hub 220 to be rotationally decoupled. In some embodiments, the drive hub includes a drive square 402 is provided to receive the lock spindle and to transfer rotational motion from the drive hub to the lock spindle such as for moving a latch for the purpose of unlatching.

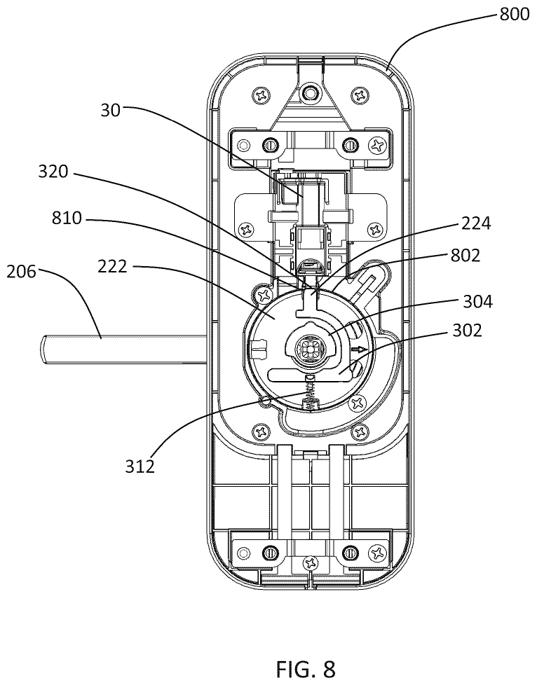

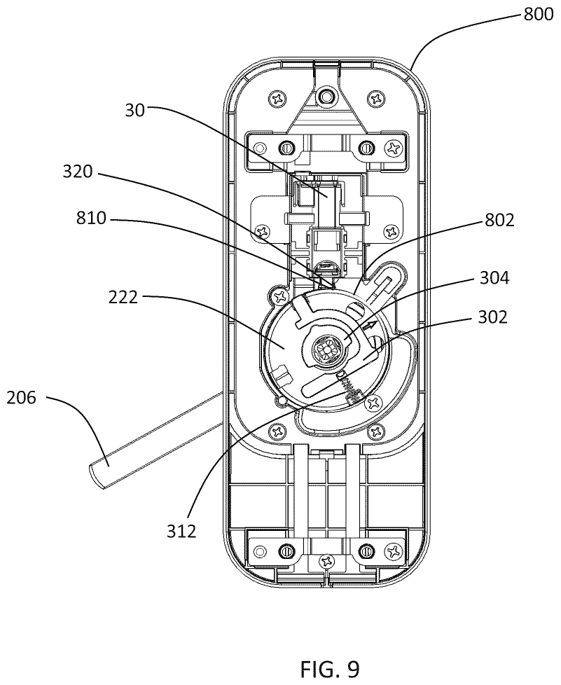

FIG. 4B illustrates the drive hub and slider in an unlocked state. The drive hub 220 slidably supports the slider 302. The dog 224 portion of the slider 302 is inside the diameter of the disc forming the drive hub 220. In the unlocked state, the dog 224 may be in a position to engage the notch in the lever hub (for example, see FIG. 5) such that the dog will operatively connect the lever hub and the drive hub to rotate together about a lock axis about which the lock spindle and door handle rotate. Note that the slider 302 may be held in the unlocked state by a ram of the actuator when the door handle is in a free or neutral position, or by a drive hub housing (for example, see FIGS. 8-9) when the door handle is in a door-unlatched position. If the slider 302 were released (e.g., by an actuator) while in the unlocked state, the slider would return to the locked state configuration in FIG. 4A under the biasing force of the spring 312 as shown in FIG. 4A. The spring 312 is not shown in FIG. 4A for clarity, but would be present in a compressed state.

FIG. 5 shows an exploded perspective view of the lock clutch of FIGS. 3A-3B. The drive hub 220 slidably supports the slider 302 biased into the locked state by the spring 312 (and a magnet, not shown). The lever hub 222 faces the drive hub 220 and spaced from it. The lever hub and the drive hub are centered to rotate about the lock axis. In the illustrated embodiment, the dog 224 may engage notch 340 in the lever hub to lock rotation of the lever hub and the drive hub about the lock axis so that the lever hub 222 and drive hub 220 are coupled. In the illustrated embodiment, a portion of the slider 302 may remain engaged in notch 342 of the drive hub 220 even when the slider is in a locked state.

In some embodiments as shown in FIG. 5, a lower arm 502 of the slider 302 may interact with the cam 304. According to some embodiments, cam 304 may be connected to rotate with the lock spindle. A user may cause rotation of the lock spindle, such as from a door lock or exit device which may be on an opposite side of a door from the lock depicted in the figures. Rotation of the cam 304 may bring lobe 504 against the lower arm 502. Further rotation of the cam moves the lower arm/slider into the unlocked state allowing the door to open. In some applications, it may be desirable to lock one side of a door (such as an exterior side) while maintaining another side (such as an interior side) in an unlocked state. An emergency exit may be one such example.

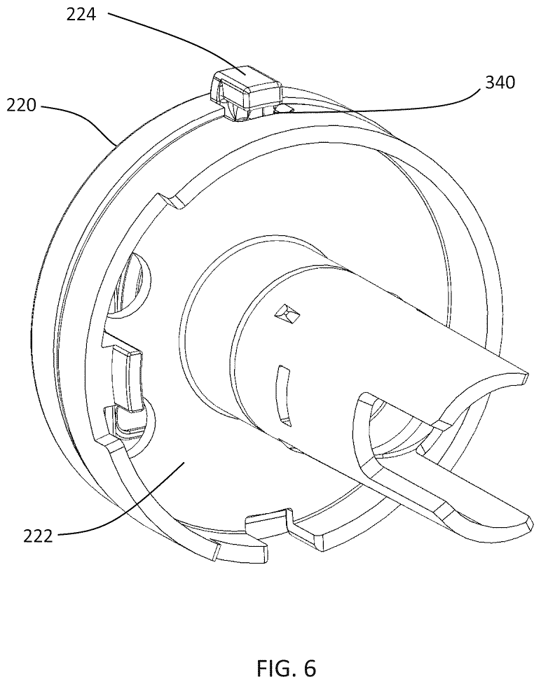

FIG. 6 shows a perspective view of the assembled lock clutch of FIG. 5. The drive hub 220 faces the lever hub 222 and spaced from it with the slider disposed therebetween. In some embodiments as shown in FIG. 6, only the dog 224 of the slider is visible in the assembled clutch. The dog 224 is shown in the locked state, disengaged from notch 340. In this illustrated position, rotation of the lever hub 222 about the lock axis will not be transferred to the drive hub 220.

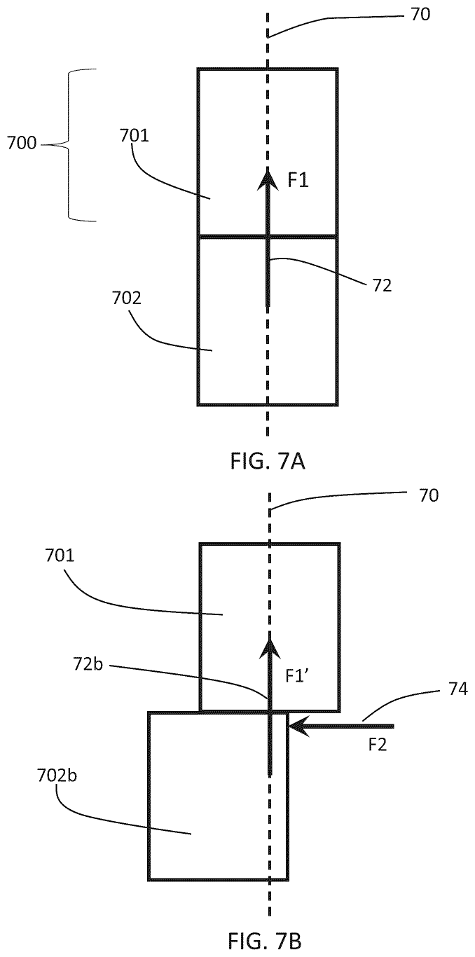

FIGS. 7A and 7B show a schematic of the magnetic attraction and forces existing between an actuator and a slider. As shown in FIG. 7A, a ram 700 of an actuator is illustrated in contact with a portion of a slider 702 (such as when in the locked state). The ram 700 includes a magnet 701 disposed on or within the ram. The actuator may move the ram 700 along an actuator axis 70. The magnet 701 may cause a magnetic attraction producing a force 72 to bias the portion of the slider 702 toward the magnet 701. The force 72 has a magnitude F1 and is directed along the actuator axis 70. If the magnet 701 and slider 702 were to be separated in a direction parallel to the actuator axis 70, a separation force greater than F1 may be exerted, such as by the actuator.

FIG. 7B illustrates the separation of the magnet 701 from the displaced slider 702b (the slider 702 is the same component as the displaced slider 702b). The magnetic attraction between the magnet 701 and the displaced slider 702b results in a force 72b having a magnitude F1′ (the magnitude of force 72b may be equal to the magnitude of force 72 or it may differ from force 72 due to a differing alignment between the manet and the slider, for instance F1′ of force 72b may be less than F1 of force 72). A force 72 having a magnitude F2 and a direction orthogonal to the force 72/72b applied by the magnet (and therefore force 74 may be orthogonal to the actuator axis 70) may be applied to separate the magnet 701 from the slider 702/702b. The magnitude F2 may be less than either of the magnitude of force 72/72b. It may therefore require less force to separate the magnet from the slider by moving (e.g., translating) the magnet in a direction transverse (e.g., orthogonal) to the force applied by the magnet than would be required to separate the slider and magnet in the direction of the actuator axis.

Without wishing to be bound by theory the force to separate the magnetic from the slider by orthogonal translation may be less than the force required to separate the magnet from the slider in the direction of the force applied by the magnet. A force to separate the slider from the magnet may be equal to a coefficient of friction existing between the magnet and the slider multiplied by a magnitude of the force resulting from the magnetic attraction. As the coefficient of friction may be less than unity for the typical materials the force to translate orthogonally (e.g., F2 of force 74) may be less than the force from magnetic attraction (e.g., F1 or F1′ of 72/72b respectively). The coefficient of friction between the slider and the magnet may be substantially less than unity in some embodiments. The coefficient of friction between the slider and the magnet may be 0.8, 0.6, 0.5, 0.3, 0.2, 0.1 or less than 0.1. The force of the aligned magnet/slider (e.g., F1 of force 72) may be less than or substantially equal to that of the magnet and slider during orthogonal translation (e.g., F1′ of force 72b) and may further decrease with increasing misalignment of the magnet and slider. Additionally, the force to move the slider in an orthogonal direction may come from a different source than a force applied by the actuator. For instance, the force to translate the slider in an orthogonal direction may be generated by a user turning a door handle while an actuator force may be supplied by a battery. Separating the magnet from the slider by orthogonal translation may extend battery life for an electric lock, may reduce a required actuator strength and/or may provide other benefits.

FIG. 8 shows a rear view of a door lock of FIG. 2 with some components removed for clarity of the illustration. Specifically, the mounting plate, drive hub and other components have been omitted to show components located underneath. A portion of the lock chassis 800 is shown supporting components of the lock. The lever hub 222 and slider 302 are shown assembled in the lock. The actuator 30 is holding the slider 302 in the unlocked state by applying an actuator force to a portion of slider (such as to the dog 224) to hold the slider in the unlocked state against a force provided by the spring 312. Contact between the slider 302 and the actuator occurs at the magnet 320 located on the ram of the actuator. A drive hub housing 802 surrounds the lever hub and a portion of the drive hub (omitted for clarity). A slot 810 in the drive hub housing 802 allows a portion of the slider 302 (including the dog 224) to extend outward from the drive hup housing. In a locked state, a portion of the slider enters the slot 810. The engagement of the slider 302 (e.g., at least the dog) with the slot 810 then further resists rotation of the drive hub and therefore the lock spindle in the locked state. The actuator 30 may move the slider through the notch such that the actuator contacting surface of the slider is tangent with an interior surface of the drive hub housing. The magnetic attraction of the magnet 320 with the slider 302 further biases the slider to remain in the position associated with a locked state (and the lock therefore to corresponding remain in a locked state). The force provided by the magnet may supplement the spring 312 in holding the slider in the locked state, such as in the presence of vibration or impact which may otherwise momentarily weaken the contact between the ram of the actuator and the slider.

As illustrated in FIG. 8, the actuator 30 is holding the slider 302 in the unlocked state. The dog 224 on the slider would be engaged with a notch on the drive hub (drive hub not shown) allowing the lever hub and drive hub to rotate together about the lock axis. The slider (along with the drive hub and lever hub 222) may then rotate with rotation of the door handle 206 allowing the dog 224 to move orthogonal to the actuator axis. In such a motion, the dog 224 moves from being aligned with and in contact with the ram of the actuator to being in contact with an inside surface of the drive hub housing 802. The drive hub housing 802 then supports a portion of the slider 302 thereby holding the slider in a position consistent with the unlocked state of the lock. The slider will remain supported by the drive hub housing 802 at least until the slider returns into a position where it abuts the ram/magnet 320 of the actuator and/or the slot 810.

FIG. 9 shows a rear view of the lock as illustrated in FIG. 8 in the unlocked state and with the door handle turned to unlatch the door. The door handle 206 is turned from the neutral/free position such as to unlatch the door. The lever hub 222, being operatively connected to the door handle, is also rotated accordingly. The slider 302 has moved away from the magnet 320 on the ram of the actuator (in the slot 810). The slider is supported by the drive hub housing 802 as illustrated. The drive hub housing 802 supports a portion of the slider against an inside surface of the drive hub housing. The slider 302 is therefore held in a position corresponding to the unlocked state at least until the door handle 206 is released allowing the slider to pass back onto the magnet 320 of the actuator at which point the positions of the ram of the actuator will determine whether the slider is in an unlocked or a locked state. As in FIG. 8, the drive hub is omitted for clarity, were the drive hub shown, it would be rotated as with the lever hub 222 and would be rotationally locked with the lever hub by a portion of the slider 302 (e.g. the dog) engaging with the notch in the drive hub.

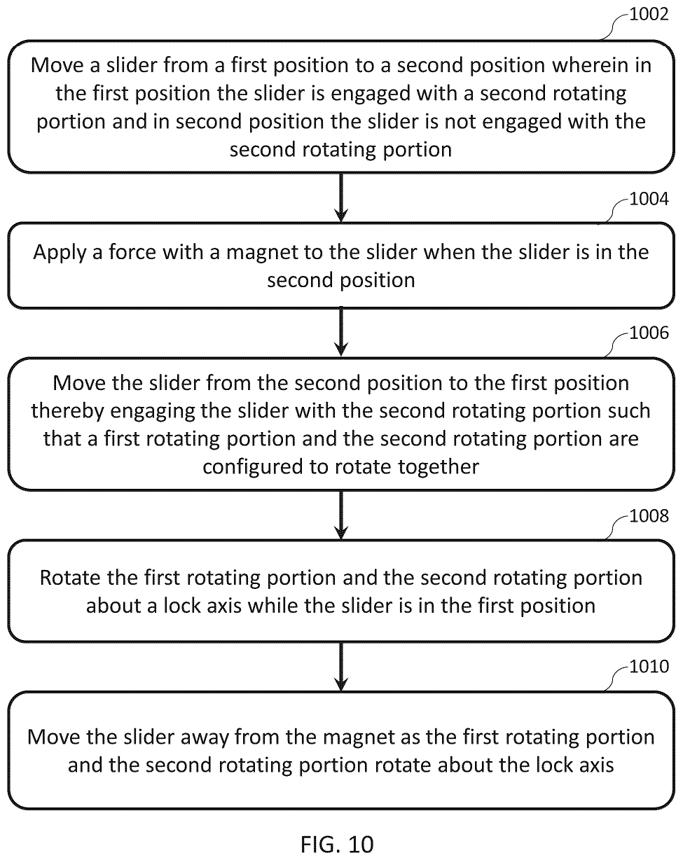

FIG. 10 illustrates a flow chart of an embodiment of a method for operating a lock clutch according to some embodiments. In block 1000, a slider engaged with a first rotating portion is moved from a first position to a second position. In the first position, the slider is engaged with a second rotating portion, locking the first rotating portion and the second rotating portion together for rotation about a lock axis (e.g., when the door handle is turned). In second position the slider is not engaged with the second rotating portion. According to some embodiments, the first rotating portion may include the drive hub and the second rotating portion may include the lever hub. The first rotating portion may include a first rotating disk and the second rotating portion may include a second rotating disk. One of the first rotating portion and the second rotating portion may be coupled to (or include) a door handle and the other of the first rotating portion and the second rotating portion may be coupled to (or include) a lock spindle. According to some embodiments, the first rotating portion may include the lock spindle and the second rotating portion may include the door handle. The portion of the slider that may engage with the second rotating portion may be a dog. In block 1004, a force is applied with a magnet to the slider when the slider is in the second position. The force resulting from the magnetic attraction (e.g., a magnetic force) is directed to hold the slider in the second position. The second position may be a locked state of the clutch corresponding to a locked state of the door lock. The force provided by the magnet may bias the slider toward a portion of the actuator and may encourage contact between the slider and the actuator in both the locked and unlocked states of the slider.

In block 1006, the slider is moved from the second position to the first position thereby engaging at least a portion of the slider with the second rotating portion such that the first rotating portion and the second rotating portion are configured to rotate together. This action may switch the clutch to an unlocked state, corresponding to an unlocked state of the door lock. According to some embodiments, the engaging portion of the slider may be a dog. The dog may engage with a notch in the second rotating portion. The notch in the second rotating portion may be a dog engagement notch formed in the lever hub. The slider may remain at least partially engaged with the drive hub in both the locked state and the unlocked state. In block 1008, the first rotating portion and the second rotating portion are rotated about a lock axis with the slider in the first position (corresponding to the lock being in an unlocked state). In block 1010, rotating the first rotating portion and the second rotating portion about a lock axis may cause the slider to move away from the magnet as the first rotating portion and the second rotating portion rotate about the lock axis. In some embodiments, a ferromagnetic portion of the slider may be moved along a path at least initially orthogonal to a direction of the magnetic force applied to the slider from the magnet. In some embodiments, a dog of the slider may move from being in contact with a portion of the actuator (e.g., a ram portion of the actuator which may include the magnet) to being in contact with an inside surface of a drive hub housing. The inside surface of the drive hub housing may have an inside diameter that is larger than an outside diameter of the drive hub and/or the lever hub. The inside diameter of the drive hub housing may be concentric with the drive hub and located on the lock axis. The drive hub housing may have a drive hub housing radius measured from the lock axis to the inside surface (e.g., the inside circumference) of the drive hub housing. In the unlocked state of the lock, a portion of the actuator (e.g., the ram and/or magnet) may be located from the lock axis by a distance equal to or approximately equal to the drive hub housing radius. The slider (e.g., some portion of the slider such as a dog) may move along the inside surface of the drive hub housing along a portion of the inside circumference of the drive hub housing. The portion of the inside circumference of the drive hub housing may correspond to an angular displacement of the door handle. According to some embodiments, a magnet may be located within a portion of the slider and may be attracted to a portion of an actuator such as a ram. In such embodiments, rotation of the first rotating portion and the second rotating portion while the slider is in the first position may move the magnet away from the actuator. A user may unlatch a door by rotating the first rotating portion and the second rotating portion with the slider in the first position (corresponding to the unlocked state of the door lock).

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A clutch for a door lock, comprising:
a first rotating portion operatively couplable to a door handle;
a second rotating portion operatively couplable to a lock spindle and configured to rotate to unlatch a door;
a slider disposed at least partially between the first rotating portion and the second rotating portion and configured to move between a first position and a second position to operatively engage and disengage, respectively, the first rotating portion and the second rotating portion; and
a magnet configured to apply a magnetic force to the slider to bias the slider toward the second position.

2. The clutch of claim 1, further comprising an actuator configured to move the slider between the first position and the second position, wherein the magnet is configured to magnetically attract the slider toward the actuator.

3. The clutch of claim 2, wherein the actuator is an electric actuator.

4. The clutch of claim 2, wherein the slider further comprises a second magnet configured to apply a second magnetic force between the actuator and the slider.

5. The clutch of claim 1, the first rotating portion includes a first notch, wherein the second rotating portion includes a second notch, wherein in the first position the slider is configured to engage the first notch and the second notch to operatively connect the first rotating portion and the second rotating portion, and wherein in the second position the slider is disengaged with at least one of the first notch and the second notch so that the first rotating portion and the second rotating portion are operatively decoupled.

6. The clutch of claim 1, further comprising a housing at least partially surrounding the first rotating portion and the second rotating portion and wherein the housing comprises a slot, the slot configured to receive and engage with the slider when the slider is in the second position.

7. The clutch of claim 1, wherein the slider is formed of a ferromagnetic material.

8. A clutch for a door lock, comprising:
a first rotating portion operatively couplable to an door handle, wherein the first rotating portion is further configured to rotate with the door handle;
a second rotating portion operatively couplable to a lock spindle, wherein the first rotating portion is further configured to rotate with the lock spindle;
a slider, the slider having a dog, the slider configured to connect the first rotating portion to the second rotating portion by engaging the dog with the first rotating portion and the second rotating portion when the slider is in a first position, and wherein the slider is configured disengage the dog from the first rotating portion and the second rotating portion to decouple the first rotating portion from the second rotating portion when the slider is in a second position; and
a magnet configured to apply a magnetic force to the slider to bias the slider toward the second position when the slider is in the second position.

9. The clutch of claim 8, further comprising an actuator configured to move the slider from the second position to the first position.

10. The clutch of claim 9, wherein the actuator comprises the magnet.

11. The clutch of claim 10, wherein the magnet is configured to translate with a portion of the actuator.

12. The clutch of claim 10, wherein rotating the door handle moves the slider away from the magnet, wherein the slider moves away from the magnet in a direction orthogonal to a direction of the magnetic force applied by the magnet.

13. The clutch of claim 8, further comprising a spring configured to apply a force to the slider to bias the slider into the second position.

14. The clutch of claim 8, wherein the first rotating portion comprises a lever hub and the second rotating portion comprises a drive hub.

15. The clutch of claim 8, wherein the slider is slidably attached to the second rotating portion.

16. The clutch for a lock of claim 8, further comprising a housing at least partially surrounding the first rotating portion and the second rotating portion, wherein the housing further comprises a slot, the slot configured to receive and engage with the slider when the slider is in the second position.

17. A method for operating a lock clutch, the method comprising:
moving a slider engaged with a first rotating portion from a first position to a second position, wherein in the first position the slider is engaged with a second rotating portion, and wherein in the second position the slider is not engaged with the second rotating portion;
applying magnetic force with a magnet to the slider when the slider is in the second position to hold the slider in the second position;
moving the slider from the second position to the first position to engage the slider with the second rotating portion such that the first rotating portion and the second rotating portion are configured to rotate together;
rotating the first rotating portion about a lock axis while the slider is in the first position to rotate the second rotating portion; and
moving the magnet away from the slider as the first rotating portion and the second rotating portion rotate about the lock axis, wherein the magnet is moved along a path orthogonal to a direction of the magnetic force.

18. The method of claim 17, further comprising unlatching a door by rotating the first rotating portion and the second rotating portion with the slider in the first position.

19. The method of claim 17, wherein the slider is moved from the second position to the first position by an actuator.

20. The method of claim 17, wherein the first rotating portion is coupled to a door handle and the second rotating portion comprises a lock spindle.
